(19) United States
(12) Patent Application Publication
(10) Pub. No.: US 2021/0255502 A1
(43) Pub. Date: Aug. 19, 2021

(54) LIQUID CRYSTAL DISPLAY

(71) Applicant: BenQ Materials Corporation, Taoyuan (TW)

(72) Inventors: Chen-Kuan Kuo, Taoyuan (TW); Wei-Feng Xu, Taoyuan (TW); Yu-Jyuan Dai, Taoyuan (TW); Fung-Hsu Wu, Taoyuan (TW)

(21) Appl. No.: 16/910,185

(22) Filed: Jun. 24, 2020

(30) Foreign Application Priority Data
Feb. 18, 2020 (TW) 109105185

(51) Int. Cl. G02F 1/1335

(52) U.S. Cl. CPC G02F 1/133504; G02F 2001/133507

(57) ABSTRACT

A liquid crystal display (LCD) is provided, comprising a LCD panel, and a color enhancement film disposed on a light exit surface of the LCD panel. The color enhancement film includes a substrate, a strip-shaped micro-prism layer, and a filling layer. The strip-shaped micro-prism layer has a plurality of strip-shaped micro-prisms arranged in a first direction, and each of the strip-shaped micro-prisms has at least one inclined light-guide surface, and the inclined light-guide surface has an included angle with a normal direction of a surface of the color enhancement film on a cross section perpendicular to the first direction, wherein, the strip-shaped micro-prism layer has a first refractive index n1, the filling layer has a second refractive index n2, and n2 is more than n1. The LCD can improve the color-shift problem at side viewing angles without affecting the display quality of the front viewing angles.

This application claims the priority benefit of Taiwanese application serial No. 109105185, filed on, Feb. 18, 2020, which is incorporated herein by reference.

### BACKGROUND OF THE INVENTION

The present invention relates to a liquid crystal display, and in particular relates to a liquid crystal display with a color enhancement film for improving the color-shift and the decrease in color saturation of images at side viewing angles.

With the developing trend of the large-size liquid crystal displays, especially applications in TVs or splicing display walls, the color expression on the edge part of the large-size liquid crystal display is inconsistent to the central thereof even when viewing from the right front viewing angle, and the whole color-shift is more severe when viewing from side viewing angles. The current liquid crystal display has excellent property of wide viewing angles which make the display viewable from various viewing angles. However, because the liquid crystal molecules have different symmetries at different viewing angles which will enable the normal incident backlight and the oblique incident backlight passing through the liquid crystal display with various light paths, the quality of images generated by the oblique incident backlight passing through the liquid crystal display is not as good as that generated by the normal incident backlight passing through the liquid crystal display. It causes color washout, gray-scale inversion or color-shift at side viewing angles of the liquid crystal display and results in lower contrast or abnormal color expression.

The grayscale change of the liquid crystal display from the bright state to the dark state is not a linear relationship, thereby many standard gamma curves, such as Gamma 2.2, Gamma 1.8, are introduced to the driver to calibrate the relationship between the input voltage and the displaying brightness to make grayscale recognized by the naked eye close to linear change. However, this method can only calibrate and compensate for the grayscale change or grayscale inversion at front viewing angles instead of every viewing angle, but cannot improve the color of images on central or side viewing angles because the bright white image is formed by mixing lights emitted by different sub-pixels with different colors. For example, the white light of a conventional liquid crystal display is formed by mixing the red, green and blue lights emitted by red, green and blue sub-pixels when white backlight passes through thereof. The mixed proportion of light intensity will still be changed under various viewing angles even the light intensity under various grayscales can be adjusted to consistently change, which will result in color-shift under the same grayscale change especially the colors such as skin color well recognized by the naked eye. Even though the curve of grayscale change is consistently calibrated, minor color-shift will still be easily perceived by the naked eye.

Another way to compensate the viewing angle of the display is to dispose a diffusing film or a diffractive film onto the displaying side of the liquid crystal display to widely direct the light from the front viewing angles to the side viewing angles. However, due to the development trend of slim type optical film, the thinner optical film is difficult to guide the light with sufficient diffusing angles, because the optical film is unable to provide sufficient light path for diffusing light in thickness direction. Although the diffusing angles can be enhanced by adding diffusing particles in the optical film, the fineness of the images will be affected. With respect to the way of changing the angle of exit light by a diffractive film, since the diffraction effects at various wavelengths are various in a diffractive film, when the light from the liquid crystal display passes through the diffractive film, the color-shift of side viewing angles cannot be consistently calibrated for the light with different wavelength. Therefore, the diffractive film can only be used to enhance the intensity of light of specific wavelength because the continuous distribution of light at side viewing angles is poor.

Accordingly, this present invention discloses a novel liquid crystal display with an enhanced image quality by providing consistent color expression either at side viewing angles or front viewing angles.

### SUMMARY OF THE INVENTION

This invention is to provide a liquid crystal display comprising a liquid crystal display panel; and a color enhancement film, disposed on a light exit surface of the liquid crystal display panel, wherein the color enhancement film comprises a substrate; a strip-shaped micro-prism layer with a first refractive index n1, having a plurality of strip-shaped micro-prisms arranged in a first direction formed on the substrate, wherein a crossing angle between the first direction and the horizontal direction of the liquid crystal display panel is in the range of 90°±25°, and each of the strip-shaped micro-prisms has at least one inclined light-guide surface, and the inclined light-guide surface has an included angle θ with the normal direction of the film surface of the color enhancement film on a cross section direction perpendicular to the first direction, and the total widths of the inclined light-guide surface projected on the color enhancement film is not less than 20% and not more than 30% of the entire width of the color enhancement film; and a filling layer with a second refractive index n2 more than the first refractive index n1 disposed on the side adjacent to the liquid crystal display panel to fill and planarize the strip-shaped micro-prism layer; wherein the mean chromaticity difference Δ̅u̅′̅v̅′̅ of the side viewing angle of the liquid crystal display is not more than 0.01, and the mean chromaticity difference Δ̅u̅′̅v̅′̅ of the horizontal side viewing angle represents the arithmetic mean value of the chromaticity differences Δu′v′ of the distance from the points of the horizontal side viewing angles of 40° to 60° respectively to the point of the front viewing angles on CIE76 chromaticity coordinates.

In an embodiment of the present liquid crystal display, the difference between the first refractive index n1 and the second refractive index n2 of the color enhancement film is not less than 0.1 and not more than 0.3.

In an embodiment of the present liquid crystal display, the inclined light-guide surface of the color enhancement film has an the included angle θ more than 0° and less than 20° with a normal direction of the film surface of the color enhancement film on a cross section direction perpendicular to the first direction.

In an embodiment of the present liquid crystal display, the width of the inclined light-guide surface projected on the color enhancement film on the cross-section direction of perpendicular to the first direction is in a range of 0.015 μm to 3.5 μm.

In an embodiment of the present liquid crystal display, the height of each of the strip-shaped micro-prisms of the color enhancement film is in the range of 0.9 μm to 5 μm.

In an embodiment of the present liquid crystal display, the adjacent two inclined light-guide surfaces of the strip-shaped micro-prisms of the color enhancement film are joined directly or spaced a distance.

In a preferred embodiment of the present liquid crystal display, the adjacent two inclined light-guide surfaces of the strip-shaped micro-prisms of the color enhancement film are spaced a distance in a range of 0.38 μm to 12.3 μm.

In a preferred embodiment of the present liquid crystal display, the adjacent two inclined light-guide surfaces of the strip-shaped micro-prisms of the color enhancement film are symmetrical or unsymmetrical.

In a preferred embodiment of the present liquid crystal display, the adjacent two inclined light-guide surfaces of the strip-shaped micro-prisms of the color enhancement film are spaced the same or different distances.

In an embodiment of the present invention, the color enhancement film further comprises a functional layer formed thereon, wherein the functional layer is one selected from the group consisting of a hard coating layer, an anti-reflection layer and an anti-glare layer, or combinations thereof.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### BRIEF DESCRIPTION OF THE DRAWINGS

FIG. 1 is a cross-sectional view showing a liquid crystal display according to one embodiment of the present invention.

FIG. 2 is a perspective view showing a surface structure of a color enhancement film according to one embodiment of the present invention.

FIG. 3 is a cross-sectional view showing a color enhancement film according to one embodiment of the present invention for improving the pixel quality of side view images of a liquid crystal display.

FIG. 4 is a cross-sectional view showing a color enhancement film according to another embodiment of the present invention.

FIG. 5 is a cross-sectional view showing a color enhancement film according to still another embodiment of the present invention.

FIG. 6 is a cross-sectional view showing a liquid crystal display according to another embodiment of the present invention.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

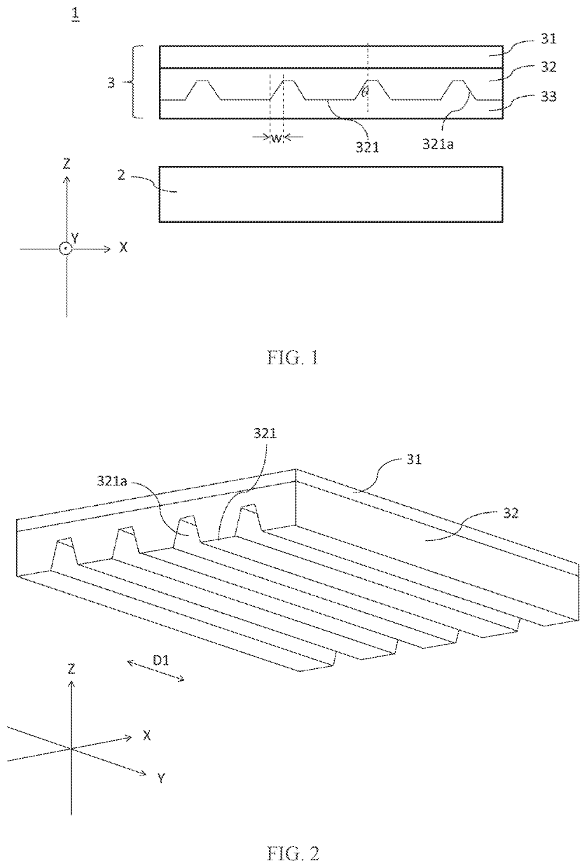

Firstly, please refer to FIG. 1 and FIG. 2. FIG. 1 is a cross-sectional view showing a liquid crystal display according to one embodiment of the present invention. FIG. 2 is a perspective view showing a surface structure of a color enhancement film according to one embodiment of the present invention. As shown in FIG. 1, the liquid crystal display 1 comprises a liquid crystal display panel 2 and a color enhancement film 3 disposed on a light exit surface of the liquid crystal display panel 2, wherein the color enhancement film 3 comprises a substrate 31, a strip-shaped micro-prism layer 32 with a first refractive index n1 having a plurality of strip-shaped micro-prisms 321 arranged in a first direction D1 formed on the substrate 31, wherein a crossing angle between the first direction D1 and the horizontal direction (X-axis) of the liquid crystal display panel 2 is in the range of 90°±25°, and each of the strip-shaped micro-prisms 321 has at least one inclined light-guide surface 321a, and the inclined light-guide surface 321a has an included angle θ with the normal direction of the surface of the color enhancement film 3 on a cross section direction perpendicular to the first direction D1, and the total widths “w” of the inclined light-guide surface projected on the color enhancement film 3 is not less than 20% and not more than 30% of the entire width of the color enhancement film 3; and a filling layer 33 with a second refractive index n2 more than the first refractive index n1 disposed on the side adjacent to the liquid crystal display panel 2 to fill and planarize the strip-shaped micro-prism layer 321; wherein the mean chromaticity difference Δ̅u̅′̅v̅′̅ of side viewing angles of the liquid crystal display 1 is not more than 0.01, wherein the mean chromaticity difference Δ̅u̅′̅v̅′̅ of side viewings angle represents the arithmetic mean value of the chromaticity differences Δu′v′ of the distance from the points of the horizontal viewing angles of 40° to 60° respectively to the point of the front viewing angles on CIE76 chromaticity coordinates.

The conventional CIEXYZ tristimulus values color coordinate system is not capable to accurately express the distinguishability of naked eyes on the color-shift of different lightness, hue and saturation due to the non-uniform thereof. The industry manufacturers involving color technology usually need color-shift evaluation to maintain the color consistency. Therefore, the International Commission on Illumination (CIE) defines uniform color spaces CIE76 (L*, u*, v*) and CIE76 (L, a, b) based on the transformation of CIEXYZ color space in 1976. CIE76(L, a, b) is usually used in the printing industry; CIE76(L*, u*, v*) is usually used in color liquid crystal display industry because of its light additivity, wherein the lightness L* of the color liquid crystal display is generated by mixing different lights of various wavelengths, such as red light, green light and blue light, so that the hue and the chroma of the image will be affected when the lightness L* is changed, thereby the coordinate values (u′, v′) will be changed. Accordingly, the degree of color-shift under a specific lightness can be quantified by the chromaticity differences Δu′v′, a distance between the coordinate value (u′, v′) and the reference coordinate value in the color coordinates.

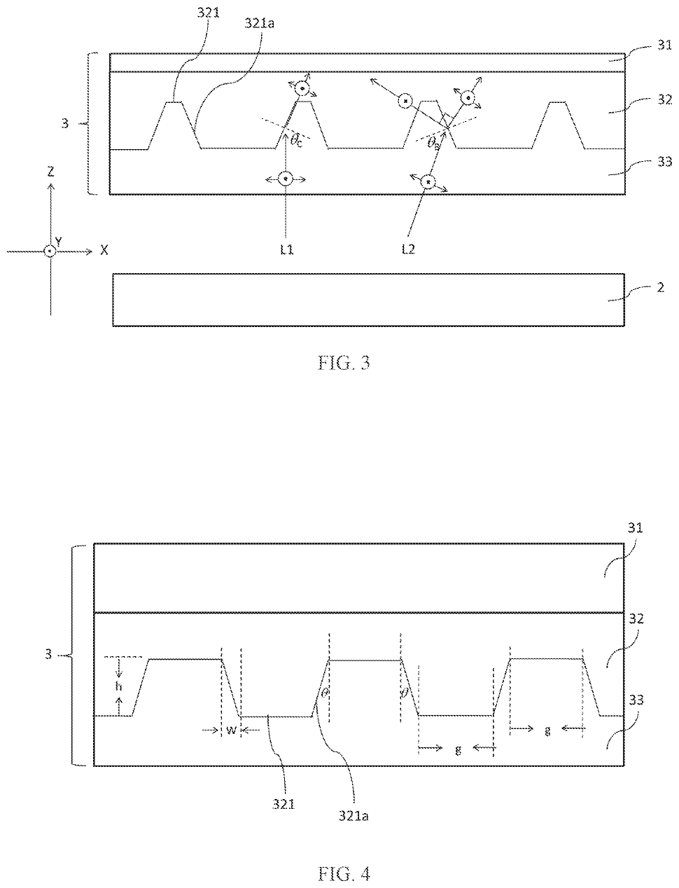

A conventional liquid crystal display panel commonly comprises a back light module, a liquid crystal cell sandwiched by two polarizer plates. The length of the liquid crystal display panel in the horizontal direction is more than that of the liquid crystal display panel in the vertical direction, so larger range of the viewing angles are included in the horizontal direction. Therefore, when a plurality of viewers are in front of a large liquid crystal display, the demands of image quality in the horizontal direction will be more than that in the vertical direction. Please also refer to FIG. 3. FIG. 3 is a cross-sectional view showing a liquid crystal display with a color enhancement film according to an embodiment of the present invention improving the image quality at side view. As shown in FIG. 3, a plurality of strip-shaped micro-prisms 321 of the strip-shaped micro-prism layer 32 are arranged to extend along with the first direction D1 and crossed the horizontal direction (X-axis) of the liquid crystal display panel 2 at an included angle in the range of 90°±25°. Lights L1, L2 from the liquid crystal display panel 2 can be reflected by total reflection and the polarization effect of the Brewster angle via the plurality of inclined light-guide surfaces 321a of the strip-shaped prisms 321. Because the lights through this light path can be largely deflected without being scattered and refracted many times, the additional color-shift to the liquid crystal display caused by dispersion of the lights of different wavelengths at the interfaces of different refractive indexes for multiple deflection and splitting of the lights can be lowered during the lights being directed to side viewing angles in the color enhancement 3. Because the refractive index n2 of the filling layer 33 is more than the refractive index n1 of the strip-shaped micro-prism layer 32, when the incidental angle of the light L1 in the area of the front viewing angles relative to the inclined light-guide surfaces 321a is not smaller than the critical angle θ_{c} calculated based on the equation (1), the light L1 will be totally reflected on the inclined light-guide surface 321a without losing the intensity thereof. With respect to the light L2 which is not totally incident from front viewing angles but still has minor color-shift than that of the light incident from side viewing angles, it still can produce reflected light polarized in the Y-axis when the incident angles relative to the inclined light-guide surface 321a is close to the Brewster angle θ_{B} calculated based on the equation (2). Because the light emitted by the polarizer (not shown) disposed on the displaying side of the liquid crystal display panel 2 is highly polarized, most of the light L2 emitted from the liquid crystal display panel 2 is the polarized light of Y-axis component. When the absorption axis of the polarizer disposed on the displaying side of the liquid crystal panel 2 is along with the X-axis, the color enhancement film 3 can provide an advanced reflection-guiding effect when the included angle θ between the first direction D1 of the strip-shaped micro-prisms 321 and the horizontal direction of the liquid crystal display panel 2 is in the range of 90°±25°

θ_{c}=sin⁻¹(n1/n2) (1)

θ_{B}=tan⁻¹(n1/n2) (2)

According to one embodiment of this present invention, the strip-shaped micro-prism layer 32 can be obtained by embossing a curable resin (not shown) with a first refractive index n1 to form a plurality of strip-shaped micro-prisms 321 on a substrate 31 and curing thereafter. Then, a second curable resin (not shown) with a second refractive index n2 is used to fill and planarize the strip-shaped micro-prism layer 32 to form a filling layer 33. The first curable resin and the second curable resin can be a photo-curable resin or a thermal-curable resin. The first refractive index n1 and the second refractive of n2 are optionally in the range of 1.4 to 1.7, wherein the difference of n2 and n1 is not less than 0.1 and not more than 0.3, and n2 is more than n1. The first curable resin and the second curable resin can be for example independently selected from the group consisting of acrylic resin, silicone resin, polyurethane resin and epoxy resin, or combinations thereof.

According one embodiment according to this present invention, the substrate 31 of the color enhancement film 3 can be for example but not limited to polyethylene terephthalate (PET), polycarbonate (PC), triacetate cellulose (TAC), polymethyl methacrylate (PMMA), polyimide (PI) or cyclo olefin polymer (COP), and has a thickness of 30 μm to 300 μm.

Next, please refer to FIG. 1 and FIG. 4. FIG. 4 is a cross-sectional view showing a color enhancement film according to one embodiment of the present invention. In one embodiment of this invention, each of the strip-shaped micro-prisms 321 has at least one inclined light-guide surface 321a, and the inclined light-guide surface 321a of the strip-shaped micro-prisms 321 has an included angle θ of more than 0° and less than 20° with the normal direction of the film surface of the color enhancement film 3 on the cross section direction perpendicular to the first direction. By controlling the range of the included angle θ, appropriate amount of light with lower color-shift can be emitted from the front viewing angles of the liquid crystal panel to pass through the incident angle satisfied the range of the critical angle θc and the Brewster angle θ_{B} as mention above to reflect sufficient light to the side viewing angles of greater range. The total widths of each inclined light-guide surface 321a of the strip-shaped micro-prisms 321 projected on the cross section direction of the color enhancement film 3 perpendicular to the first direction is not less than 20% and not more than 30% of the entire width of the color enhancement film 3, so as to avoid the insufficient luminous flux of effective guiding light or the decrease of brightness and contrast of front viewing angles caused by excess or insufficient effective light guiding area of the inclined light-guide surfaces 321a. The entire width of the color enhancement film 3 is dependent on the size of the liquid crystal display panel instead of a constant value, and the color enhancement film 3 is manufactured by for example micro-engraving and embossing process to generate a repeat unit of a plurality of strip-shaped micro-prisms 321 and repeat these repeat units on the color enhancement film 3 to generate a plurality of strip-shaped micro-prism layer 32 thereon. Therefore, the ratio of the total widths “w” of the inclined light-guide surface 321a of the strip-shaped micro-prism layer 32 over the entire width of the color enhancement film 3 can be obtained by calculating the ratio of the widths “w” of the inclined light-guide surfaces 321a over the repeat units. The width “w” of each of inclined light-guide surface 321a of the strip-shaped micro-prisms 321 projected on the cross-section direction perpendicular to the first direction of the color enhancement film 3 is in the range of 0.015 μm to 3.5 μm, and the height “h” of each of strip-shaped micro-prisms 321 is in the range of 0.9 μm to 5 μm.

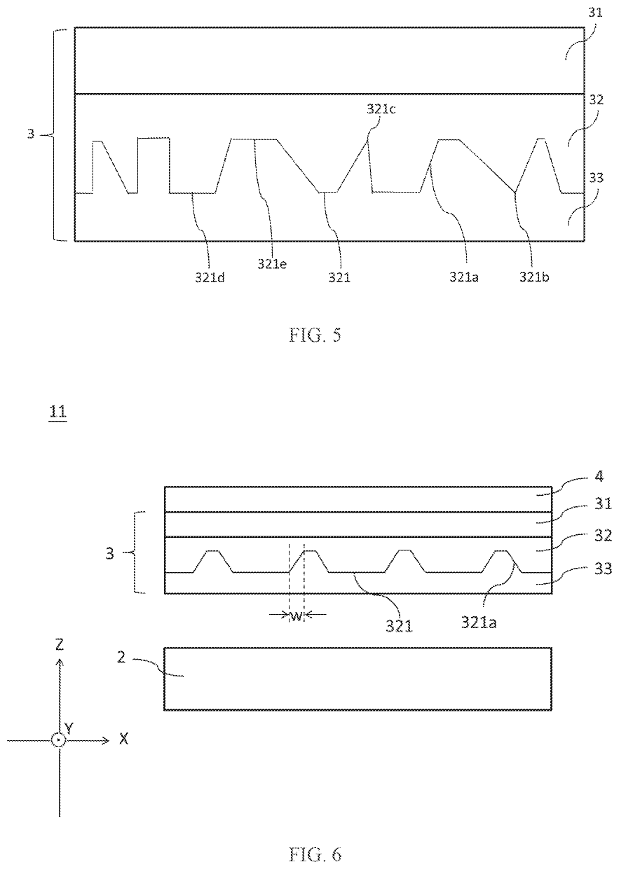

Please refer to FIG. 4 and FIG. 5. FIG. 5 is a cross-sectional view showing a color enhancement film according to another embodiment of the present invention.

As the color enhancement film 3 shown in FIG. 5, each strip-shaped micro-prism 321 arranged in the first direction has a inclined light-guide surface 321a on one side thereof or have two inclined light-guide surfaces 321a on two sides thereof, and adjacent two inclined light-guide surfaces 321a of the strip-shaped micro-prisms 321 are joined directly or spaced by a distance “g”. When two adjacent inclined light-guide surfaces 321a of the strip-shaped micro-prisms 321 are joined directly, a triangular strip-shaped micro-prism 321 with a top end 321b can be obtained or two adjacent strip-shaped micro-prisms are joined by the lower end 321c therebetween. When two adjacent inclined light-guide surfaces of the strip-shaped micro-prisms are spaced by a distance “g”, the distance “g” can be defined as the shortest distance therebetween. The distance “g” is used to regulate the percentage of the total widths of the inclined light-guide surfaces 321a over the entire width of the color enhancement film 3 in order to optimize the color-shift phenomena of side viewing angles of various liquid crystal displays rather than to make the light reflect in large scale as that achieved by the inclined light-guide surfaces 321a. Therefore, the distance “g” is not limited to present on the top surface 321d or on bottom surface 321e of individual strip-shaped micro-prism 321, and the distance “g” is in the range of 0.38 μm to 12.3 μm. According to another embodiment of this present invention, the strip-shaped micro-prisms 321 can be design based on the arrangement, size of pixels of the liquid crystal display or the design or the requirements thereof. The strip-shaped micro-prisms 321 can be independently the same or partial the same. Therefore, two adjacent inclined light-guide surfaces 321a of the strip-shaped micro-prisms 321 can be symmetrical or unsymmetrical, and the distance “g” between two adjacent inclined light-guide surfaces 321a of the strip-shaped micro-prisms 321 can be the same or different.

Please refer to FIG. 6. A liquid crystal display 11 according to another embodiment of this present invention further comprises a functional coating layer 4 on the substrate 31 of the color enhancement film 3. The functional coating layer 4 can be selected from the group consisting of a hard coating layer, an anti-reflection layer and an anti-glare layer, or combinations thereof.

The present invention will be described below with reference to Examples to describe the present invention in detail but the present invention is not limited to the description thereof.

### EXAMPLE

### Example 1

A color enhancement film according to this present invention was disposed on the polarizer attached on the displaying side of a liquid crystal display (Model: BenQ 50JM700). The color enhancement film comprises a strip-shaped micro-prism layer with a first refractive index n1 of 1.51, and a filling layer with a second refractive index n2 of 1.61, and the first direction D1 that a plurality of strip-shaped micro-prisms being along with and the horizontal direction of the liquid crystal display panel cross at an angle of 70°, and the ratio of the total widths “w” projected on the color enhancement film is 29.7% of the entire width of the color enhancement film, wherein the individual widths “w” are in the range of 1.10 μm to 1.34 μm, and the inclined light-guide surface of the strip-shaped micro-prism has an included angle θ of 12.5° with the normal direction of the surface of the color enhancement film on a cross section perpendicular to the first direction and the inclined light-guide surface of strip-shaped micro-prism has an included angle θ of 15° with the normal direction of the surface of the color enhancement film on a cross section direction perpendicular to the first direction are alternatively and unsymmetrically arranged on the strip-shaped micro-prism layer, and the height of each strip-shaped micro-prism is 5 μm.

### Example 2

A color enhancement film was disposed on the polarizer on the displaying side of a liquid crystal display (Model: SAMSUNG C32H711QEE). The color enhancement film comprises a strip-shaped micro-prism layer with a first refractive index n1 of 1.51, and a filling layer with a second refractive index n2 of 1.61, and the first direction D1 that a plurality of strip-shaped micro-prisms being along with and the horizontal direction of the liquid crystal display panel cross at an angle of 75°, and the ratio of the total widths “w” projected on the color enhancement film is 20% of the entire width of the color enhancement film, wherein the individual widths “w” are in the range of 0.88 μm to 1.34 μm, and the inclined light-guide surface of strip-shaped micro-prism has an included angle θ of 10° with the normal direction of the surface of the color enhancement film on a cross section perpendicular to the first direction and the inclined light-guide surface of strip-shaped micro-prism has an included angle θ of 15° with the normal direction of the surface of the color enhancement film on a cross section direction perpendicular to the first direction are alternatively and unsymmetrically arranged on the strip-shaped micro-prism layer, and the height of each strip-shaped micro-prism is 5 μm.

### COMPARATIVE EXAMPLE

### Comparative Example 1

The liquid crystal display is the same as that in Example 1, but there is no color enhancement film disposed thereon.

### Comparative Example 2

The liquid crystal display is the same as that in Example 2, but there is no color enhancement film disposed thereon.

As shown in Table 1, chromaticity differences Δu′v′ of viewing angles at horizontal side viewing angles of 0° to 80° relative to the front viewing angle of 0° on CIE76 chromaticity coordinates are obtained by calculating the chromaticity difference on CIE 76 (L*, u*, v*) color space coordinates (u′,v′) converted from emission spectrum data of a bright white image of above-mentioned Examples and Comparative Examples measured at horizontal side viewing angles of 0° to 80° by the Autronic-Melcher Conoscope 80 and on CIE 76 (L*, u*, v*) color space coordinates (u′,v′) converted from emission spectrum data of a bright white image of above-mentioned Examples and Comparative Examples measured at a front viewing angle of 0° by the Autronic-Melcher Conoscope 80. As shown in Table 1, owing to the color accuracy at front viewing angles of the conventional liquid crystal display has been optimized, the chromaticity difference Δu′v′ of the horizontal side viewing angles of 0° to 30°, close to the front viewing angle, measured on the bright white image without a color enhancement film of the present invention disposed thereon in Comparative Example 1 and the chromaticity difference Δu′v′ of the horizontal side viewing angles of 0° to 20°, close to the front viewing angle, measured on a bright white image without a color enhancement film of the present invention disposed thereon of Comparative Example 2 was a smaller valve, that is less than 0.01. It is noted that color-shift will not be able to be perceived by the naked eye when chromaticity difference Δu′v′ is less than 0.01. However, as shown in Table 1, chromaticity differences Δu′v′ of Comparative Examples 1 and 2 are increased to more than 0.01 with horizontal side viewing angles increased, for example horizontal side viewing angles increased to more than 40°, the more color-shift will be perceived by the naked eye. As shown in Table 1, chromaticity differences Δu′v′ of Examples 1 and 2 measured at horizontal side viewing angles of 40° to 80° on liquid crystal displays with color enhancement films of the present invention are lower than those obtained in Comparative Examples 1 and 2. Particularly, chromaticity differences Δu′v′ at horizontal side viewing angles of 40° to 60° and arithmetic mean chromaticity difference Δ̅u̅′̅v̅′̅ between 40° to 60° obtained in Examples 1 and 2 are all less than 0.01, which results in unperceived color-shift by naked eye and the chromaticity difference Δu′v′ obtained at front viewing angles of 0° to 30° is still less than 0.01 without losing significant lights at front viewing angles under high light conducting effect provided by the present color enhancement film. Accordingly, the liquid crystal display according to this present invention can provide displaying images with a uniform color-shift from front viewing angles to side viewing angle in the range of 40° to 60°, thereby to enhance the consistency and quality of displaying images thereof.

TABLE 1
Chromaticity differences (Δu′v′) of a bright white image measured at different horizontal side viewing angles

| | | | | | | | | | | Mean |
|---|---|---|---|---|---|---|---|---|---|---|
| | | | | | | | | | | chromaticity |
| | | | | | | | | | | difference |
| Chromaticity | | | | | | | | | | Δ̅u̅′̅v̅′̅ |
| difference | Horizontal viewing angle | | | | | | | | | between 40° |
| (Δu′v′) | 0° | 10° | 20° | 30° | 40° | 50° | 60° | 70° | 80° | to 60° |
| Example 1 | 0 | 0.0033 | 0.0050 | 0.0064 | 0.0076 | 0.0060 | 0.0037 | 0.0191 | 0.0286 | 0.0058 |
| Example 2 | 0 | 0.0030 | 0.0042 | 0.0075 | 0.0064 | 0.0063 | 0.0026 | 0.0156 | 0.0258 | 0.0051 |
| Comparative | 0 | 000011 | 0.0061 | 0.0055 | 0.0101 | 0.0094 | 0.0182 | 0.0329 | 0.0332 | 0.0126 |
| Example 1 | | | | | | | | | | |
| Comparative | 0 | 0.0053 | 0.0056 | 0.0113 | 0.0113 | 0.0107 | 0.0106 | 0.0251 | 0.0299 | 0.0109 |
| Example 2 | | | | | | | | | | |

While the invention has been described by way of example(s) and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display, comprising:
a liquid crystal display panel; and
a color enhancement film, disposed on a light exit surface of the liquid crystal display panel, wherein the color enhancement film comprising:
a substrate;
a strip-shaped micro-prism layer with a first refractive index n1, having a plurality of strip-shaped micro-prisms arranged in a first direction on the substrate, wherein a crossing angle between the first direction and the horizontal direction of the liquid crystal display panel is in the range of 90°±25°, and each of the strip-shaped micro-prisms has at least one inclined light-guide surface, and the inclined light-guide surface has an included angle θ with a normal direction of a surface of the color enhancement film on a cross section perpendicular to the first direction, and the total widths of the inclined light-guide surface projected on the color enhancement film is not less than 20% and not more than 30% of the entire width of the color enhancement film; and
a filling layer with a second refractive index n2 more than the first refractive index n1, filling and planarizing the strip-shaped micro-prism layer and disposing on the side adjacent to the liquid crystal display panel;
wherein, the mean chromaticity difference Δ̅u̅′̅v̅′̅ of side viewing angles of the liquid crystal display is not more than 0.01, and the mean chromaticity difference Δ̅u̅′̅v̅′̅ of side viewing angles represents the arithmetic mean value of chromaticity differences Δu′v′ of the distance from the points of the horizontal viewing angles of 40° to 60° respectively to point of the front viewing angle 0° on CIE76 chromaticity coordinates.

2. The liquid crystal display as claimed in claim 1, wherein the difference between n1 and n2 is not less than 0.1 and not more than 0.3.

3. The liquid crystal display as claimed in claim 1, wherein the included angle θ is more than 0° and less than 20° with a normal direction of a the film surface of the color enhancement film on a cross section direction perpendicular to the first direction.

4. The liquid crystal display as claimed in claim 1, wherein the width of the inclined light-guide surface projected on the cross-section perpendicular to the first direction of the color enhancement film is in a range of 0.015 μm to 3.5 μm.

5. The liquid crystal display as claimed in claim 1, wherein the height of each of the strip-shaped micro-prisms is in a range of 0.9 μm to 5 μm.

6. The liquid crystal display as claimed in claim 1, wherein adjacent two inclined light-guide surfaces of the strip-shaped micro-prisms are joined directly or spaced a distance.

7. The liquid crystal display as claimed in claim 6, wherein adjacent two inclined light-guide surfaces of the strip-shaped micro-prisms are spaced a distance in a range of 0.38 μm to 12.3 μm.

8. The liquid crystal display as claimed in claim 6, wherein adjacent two inclined light-guide surfaces of the strip-shaped micro-prisms are symmetrical or unsymmetrical.

9. The liquid crystal display as claimed in claim 6, wherein adjacent two inclined light-guide surfaces of the strip-shaped micro-prisms are spaced by the same or different distances.

10. The liquid crystal display as claimed in claim 1, further comprising a functional layer formed on the color enhancement film, wherein the functional layer is selected from the group consisting of a hard coating layer, an anti-reflection layer and an anti-glare layer, or combinations thereof.
